(19) United States
(12) Patent Application Publication
(10) Pub. No.: US 2014/0302546 A1
(43) Pub. Date: Oct. 9, 2014

(54) METHOD FOR HYDROGEN SULFIDE DETECTION

(71) Applicants: Gal Winter Ziv, Karana Downs (AU); Christopher Daniel Curtin, Stirling (AU)

(72) Inventors: Gal Winter Ziv, Karana Downs (AU); Christopher Daniel Curtin, Stirling (AU)

(73) Assignee: UNIVERSITY OF WESTERN SYDNEY, Penrith South DC (AU)

(21) Appl. No.: 14/240,755

(22) PCT Filed: Aug. 30, 2012
(86) PCT No.: PCT/AU2012/001022

§ 371 Date: Jun. 19, 2014

(30) Foreign Application Priority Data
Aug. 31, 2011 (AU) 2011903516

(51) Int. Cl. G01N 21/78

(52) U.S. Cl. CPC G01N 21/783
USPC 435/29

(57) ABSTRACT

A method for detecting H₂S produced by a microorganism comprising providing a thiazine dye to a culture medium; culturing a microorganism in the culture medium; and detecting H₂S produced by the microorganism by determining a colour change of the culture medium from an interaction of the thiazine dye with H₂S present in the culture medium.

### TECHNICAL FIELD

The present invention relates to methods for detecting hydrogen sulfide (H₂S), particularly H₂S produced by microorganisms during cell culture.

### BACKGROUND

Sulfur compounds exert a strong influence on the aroma of food and fermented beverages, due to their low detection threshold and high reactivity. Sulfur compounds are produced during microbial cell growth as a result of the microorganism metabolism. Amongst the positive contributors to foods and beverages are the polyfunctional thiols, imparting fruity aroma while a noted compound of the negative contributors is H₂S, imparting ‘rotten eggs’ aroma.

Hydrogen sulfide may be formed metabolically by microorganisms from either inorganic sulfur compounds, sulfate and sulfite, or organic sulfur compounds, cysteine and glutathione present in culture. Hydrogen sulfide, a highly volatile compound which imparts a ‘rotten egg’ aroma, is considered a major off-flavour in fermented food and beverage products. The nature of the sulfur source affects greatly on the timing for H₂S production and the final aroma of food and fermented beverages.

In microorganisms, the amount of H₂S produced during cell culture is dependent upon genetic factors of the microorganism and cell culture conditions, such as the nutrient composition of the cell growth media.

Several techniques are currently employed for the detection of H₂S after the completion of the cell culture or growth. Known qualitative methods routinely use bismuth sulfite agar plates or lead acetate strips. Known quantitative methods commonly utilise colorimetric assays. The quantitative methods commonly utilise Cd(OH)₂ and methylene blue colorimetric reaction or lead acetate detection tubes. A known high throughput method uses a membrane impregnated with silver nitrate. However, the known methods are limited in either high throughput applicability or sensitivity and do not detect natural levels of H₂S produced during cell culture. The known methods often require the addition of cysteine to the cell culture media as a sulphur source. All known methods cannot characterise genetic and cell culture factors affecting H₂S production during microbial cell culture.

There is a need for a high throughput method for the characterisation of H₂S production during microbial culture. A further need is to better understand the factors affecting H₂S production during microbial culture. There is an additional need for a method which is able to the detection of both genetic and cell culture factors affecting H₂S production during microbial culture. Another need is for high throughput analysis of H₂S production during microbial cell growth which is capable of distinguishing between the different sulfur sources.

The present inventors have developed a new method for detecting H₂S produced by a microorganism that is suitable for high throughput analysis of microbial H₂S production.

### SUMMARY

The present inventors have surprisingly found that the addition of a thiazine dye to a culture medium does not adversely effect microbial cell growth or metabolism and the dye can be used to determine H₂S production during microbial culture.

A group of dyes called “thiazine dyes” includes Methylene blue, Azure A, Methylene green, New methylene blue, Tolonium chloride, Toluidine blue and chemical variations or modifications thereof. These dyes have the potential to act similarly to methylene blue. Also, chemical variation on methylene blue or other thiazine dyes such as ethylene blue may also be suitable for the present invention. Preferably, the thiazine dye is methylene blue.

In a general aspect, the present invention relates to culturing a microorganism in the presence of a thiazine dye to determine H₂S production by the microorganism.

In a first aspect, the present invention provides a method for detecting H₂S produced by a microorganism comprising:
(a) providing a thiazine dye to a culture medium;
(b) culturing a microorganism in the culture medium; and
(c) detecting H₂S produced by the microorganism by determining a colour change of the culture medium from an interaction of the thiazine dye with H₂S present in the culture medium.

The microorganism may be a bacterium or yeast. The bacterium or yeast may be a laboratory strain or may be used in an industrial process. Preferably, the bacterium or yeast is suitable for, or used in, food or beverage production.

In a preferred form, the method is a high throughput mode wherein in step (a) the thiazine dye is provided to a plurality of vessels containing culture media; in step (b) the microorganisms are cultured in the plurality of vessels; and in step (c) H₂S produced by the microorganisms is detected by determining colour change of the culture media from an interaction of the thiazine dye with H₂S in the plurality of vessels.

Preferably the plurality of vessels is a 12, 24, 48 or 96 well microtitre plate.

The method may further comprise providing an agent to the culture medium, culturing the microorganism, and comparing H₂S production by the microorganism under similar culture conditions to those in step (c) in the absence of the agent to determine any effect of the agent on H₂S production by the microorganism.

Preferably the agent is selected from the group consisting of a nutrient, co-factor, food additive, food component, substrate, amino acid, peptide, protein, metal, and vitamin.

The culture medium may be a food or beverage or a medium derived from a food or beverage. The sample of food or beverage may be diluted to form the medium.

The thiazine dye may be added to the culture medium in an amount from about 1 μg/ml to about 1 mg/ml or more. Preferably, the thiazine dye is added to the culture medium at about 50 μg/ml. Typically, there needs to be sufficient dye present to provide a colour detectable by any suitable means.

In order to assist the thiazine dye to react with H₂S, a catalyst may also be added to the culture medium. Preferably, the catalyst is a metal cation. Preferably, the metal cation is at an oxidation number of IV selected from Se(IV), Te(IV), Ti(IV). More preferably, the transitional metal is titanium oxide or tellurium dioxide. Titanium oxide or tellurium dioxide are typically added to the culture medium at about 1 μg/ml to 1 mg/ml or more.

In some embodiments more than one catalyst may be used. For example a combination of titanium oxide and tellurium dioxide may be used.

The thiazine dye may be added to the culture medium as a mix containing a thiazine dye, catalyst and any other co-factors or buffers. An example of a suitable mix includes 5 ml of 1 mg/ml methylene blue, 1 ml of 1 mg/ml titanium oxide and 4 ml of 100 mM citric acid buffer at pH 4.5.

The culture medium may be liquid or semi solid or solid. Preferably, the culture medium is liquid or broth. The semi solid or solid culture medium may be an agar medium provided as a petri dish or a tube containing an agar slope.

The culturing a microorganism in the culture medium may be carried out in a microtitre plate having multiple wells or an array of test tubes or an array of suitable culture vessels. The culture vessels may be flasks or schott bottles or plastic centrifuge tube or glass tube or cuvette.

The microorganisms may be cultured under suitable conditions for cell growth. The culturing may occur in an incubator with or without agitation. The culturing may occur for any suitable time and temperature. Typical culture times range from about 1-5 hours and to about 60 or more hours. The culturing may occur at temperatures from about 14° C. to about 40° C. Incubation temperatures of about 21° C., or about 22° C., or about 23° C., or about 24° C., or about 25° C., or about 26° C., or about 27° C., or about 28° C., or about 29°, or about 30° C., or about 31° C., or about 32° C., or about 33° C., or about 34° C., or about 35° C., or about 36° C., or about 37° C. have been found to be suitable for a range of different microorganisms. It will be appreciated that the incubation times and temperatures may vary depending on the microorganism being cultured.

The microorganisms may be cultured aerobically, microaerobically or anaerobically.

The microorganisms may be cultured in liquid, solid or semi-solid media such as gels.

The colour change of the culture medium can be measured optically. Preferably, any colour change is monitored by a spectrophotometer, a plate reader, or image editing software. Preferably, the measurement occurs at a visible wavelength in the range of about 380 nm to about 750 nm. Preferably, the wavelength is between about 600 nm to 663 nm. More preferably, the wavelength is 663 nm. In some embodiments the wavelength is approximately equal to an absorbance maxima of the thiazine dye used.

Determining the colour change may be through a single measurement, multiple measurements or continuous measurement during the microbial culture. In some embodiments it is preferable to average multiple measurements.

If H₂S is produced, there will be a decolourisation of the medium. The present inventors have found that there is a quantitative relationship between the colour of the medium and the amount of H₂S present.

In a preferred form, a plurality of microorganisms are cultured in a plurality of culture media containing a thiazine dye and H₂S production is compared between the plurality of microorganisms, For example, microorganisms cultured in a microtitre plate containing multiple wells of culture media can be used as a high throughput assay to compare H₂S produced by different microorganisms. Similarly, the same microorganism can be tested for H₂S production in a plurality of different media.

An H₂S profile for a given microorganism may be obtained by multiple measurements or continuous measurement during the microbial culture. Preferably, continuous measurement during culture is used to obtain an H₂S profile.

It will be appreciated that the present invention maybe used to compare H₂S production from strains of a given microorganism to compare H₂S production. The strains may contain one or more mutations and mutant genotypes maybe studied for their affect on H₂S production.

The present invention is particularly useful to select suitable microorganisms for starter cultures or for microbial fermentation for the food and beverage industry. Industries that utilize such microorganisms include dairy, fermented beverages. For example, starter cultures or microbial strains may be used in the production of cheese, yoghurt, wine, beer, vinegar, fermented meat, or fermented yogurt.

In a second aspect, the present invention provides a method for determining an affect of an agent on H₂S production by a microorganism, the method comprising:
(a) providing a thiazine dye to a culture medium;
(b) providing an agent to the culture medium;
(c) culturing a microorganism in the culture medium;
(d) detecting H₂S production by the microorganism by determining a colour change of the culture medium from an interaction of the thiazine dye with H₂S; and
(e) comparing H₂S production by the microorganism under similar culture conditions to those in step (c) in the absence of the agent to determine any effect of the agent on H₂S production by the microorganism.

The agent maybe a nutrient, co-factor, food additive, food component, substrate, amino acid, peptide, protein, metal, vitamin, element or the like.

The present invention is suitable for the detection of H₂S produced by a microorganism, for example, a laboratory strain of a microorganism or a microorganism used in an industrial process.

The present invention is particularly suitable for the food and beverage industry where H₂S may be a problem of spoilage or unwanted organoleptic qualities.

In a third aspect; the present invention provides a high throughput method for detecting H₂S produced by microorganisms comprising:
(a) providing a thiazine dye to a plurality of vessels containing culture media;
(b) culturing microorganisms in the plurality of vessels; and
(c) detecting H₂S produced by the microorganisms by determining colour change of the culture media from an interaction of the thiazine dye with H₂S in the plurality of vessels.

The microorganisms may be different microorganisms or strains and the plurality of vessels contain the same culture media. In this form, H₂S production by different microorganisms can be compared under the same culture conditions.

Alternatively, the microorganisms may be the same microorganism or strain and the plurality of vessels contain different culture media. In this form, H₂S production from different media by the same microorganism can be compared.

The plurality of vessels may be a microtitre plate or the like having multiple wells. A preferred array of vessels is a 12, 24, 48 or 96 well microtitre plate but other plates with a lower or higher number of wells. are also, be suitable. Preferably the array of vessels is a 96 well plate. An advantage of such an arrangement is that small volume cultures can be carried out and handled easily with typical laboratory equipment.

The plurality of vessels may be an array of culture vessels, test tubes or any vessels suitable for the culture of microorganisms. The culture vessels may be tubes, flasks, schott bottles or the like, or plastic centrifuge tube or glass tube or cuvette.

The vessels may incubated on a rocking platform, shaking tray, water bath or any suitable incubator.

Preferably, the plurality of vessels are exposed to the same incubation conditions at substantially the same time.

In a fourth aspect, the present invention provides a kit for detecting H₂S produced by a microorganism, the kit comprising a thiazine dye and a culture vessel. The thiazine dye may be provided as aliquots in the culture vessel. Optionally the kit further contains at least one of the following: culture media, a catalyst, a H₂S standard and instructions for use. The kit may comprise a plurality of culture vessels, for example to allow the use of the kit for high throughput detection of H₂S.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this specification.

In order that the present invention may be more clearly understood, preferred embodiments will be described with reference to the following drawings and examples.

### BRIEF DESCRIPTION OF THE DRAWINGS

FIG. 1: A Reduction reaction between methylene blue and sulfide, catalysed by traces of titanium dioxide, leading to decolourisation of methylene blue. B Cell culture performance measured by CO₂ production rate.

FIG. 2: Analysis of H₂S production during cell culture using methylene blue reduction method. A Cells from an overnight culture grown on YPD were inoculated into a 96 well plate filled with model grape juice with or without methylene blue added to the cell culture medium. B H₂S production profile generated using methylene blue added to the cell culture medium (left) or using lead acetate detection tubes (right). C Method linearity, known amounts of H₂S added into a 96 well plate filled with model grape juice and methylene blue added to the cell culture medium.

FIG. 3 shows detection of genetic factors affecting H₂S production. H₂S profile generated using methylene blue added to the cell culture medium for a known high H₂S producer, AWRI1483 and a low H₂S producer, AWRI796.

FIG. 4 shows detection of cell culture factors affecting H₂S profile. A H₂S profile using lead acetate detection tubes. B H₂S profile produced for a microbial cell culture using methylene blue added to the cell culture medium.

FIG. 5 shows detection linearity using methylene blue. Known amounts of H₂S were added into a 96 well plate filled water and the reaction mix with or without addition of a catalyst (tellurium dioxide). Dye absorbance was measured at 663 nm wavelength immediately following dye addition A and after 30 minutes B. Error bars represents standard deviation.

FIG. 6 shows detection linearity using Azur A. Known amounts of H₂S were added into a 96 well plate filled water and the reaction mix with or without addition of a catalyst (tellurium dioxide). Dye absorbance was measured at 663 nm wavelength immediately following dye addition A and after 30 minutes B. Error bars represents standard deviation.

FIG. 7 shows detection linearity using toluidine blue. Known amounts of H₂S were added into a 96 well plate filled water and the reaction mix with or without addition of a catalyst (tellurium dioxide). Dye absorbance was measured at 663 nm wavelength immediately following dye addition A and after 30 minutes B. Error bars represents standard deviation.

FIG. 8 shows H₂S formation profile generated on a micro-scale fermentation using Azur A colour degradation reduction method of the present invention. Error bars represent standard deviation.

FIG. 9 shows H₂S formation profile generated on a micro-scale fermentation using toluidine blue colour degradation reduction method of the present invention. Error bars represent standard deviation.

### DETAILED DESCRIPTION

### Methods

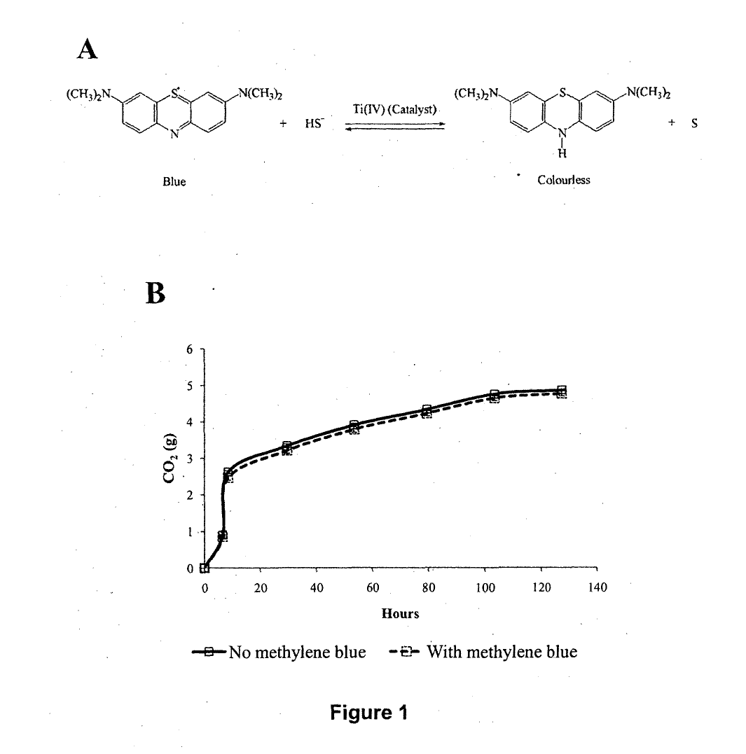

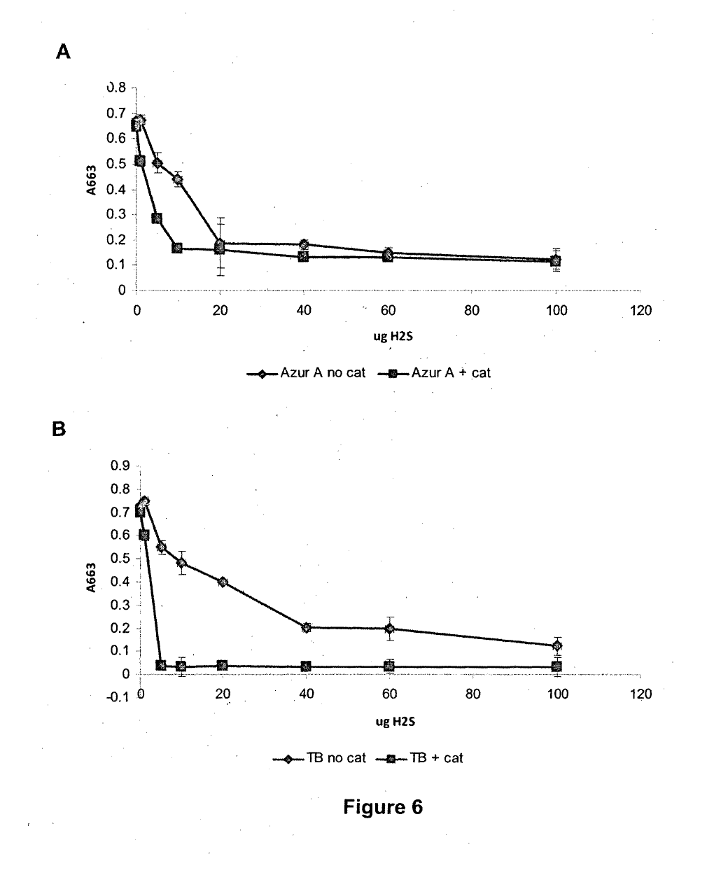

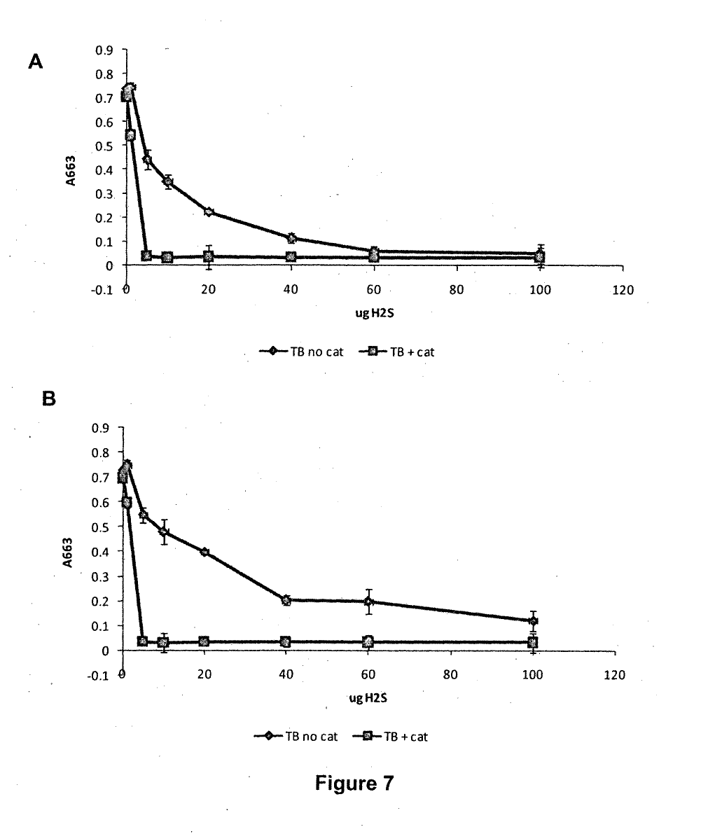

A preferred method employed a catalytic-reduction reaction between methylene blue and sulfide ions, catalysed by traces amounts of transitional metal. The reaction leads to decolourisation of methylene blue (FIG. 1A) or other thiazine dyes such as Azur A (FIG. 6) or Toluidine (FIG. 7). Under cell culture conditions, sulfide ions are present as H₂S. Incorporation of the methylene blue into the cell culture media allows the immediate in situ detection of H₂S produced during cell culture, without affecting cell culture performance (FIG. 1B). A H₂S production profile may then be generated by kinetic spectrophotometric measurements at 663 nm.

### Procedure

To demonstrate high throughput methodology, cell cultures were conducted in 96 well plate at a total volume of 200 μl per well. Each well contained 170 μl of cell culture media (model grape juice), 10 μl of microbial cells culture to give a final optical density of 0.3-0.5 at 600 nm wavelength and 20 pi of the methylene blue reaction mix. Reaction mix contained 5 ml of 1 mg/ml methylene blue, of 1 ml of 1 mg/ml titanium oxide or tellurium dioxide and 4 ml of 100 mM citric acid buffer at pH 4.5. The 96-well plate was covered with a Breathe easy membrane (Astral Scientific, Australia). Cell cultures were monitored spectrophotometrically at 663 nm and 600 nm using a 96 wells plate reader. Cell cultures were carried out in quadruplicate. Duplicate cell cultures were performed without the reaction mix to monitor microbial cell growth rate as measured by the absorbance at 600 nm. Un-inoculated wells containing cell culture media with or without reaction mix were monitored to detect media contamination, and spontaneous production of H₂S, respectively.

### Data Analysis

Kinetic spectrophotometric measurements throughout cell culture allowed the generation of H₂S production profiles. These profiles represent methylene blue decolourisation rate normalized to biomass formation, and is calculated as:

[(OD_{663 t0}−OD_{600 t0})−(OD_{663 t}−OD_{600 t})]/[OD₆₀₀ₜ, no reaction mix control].

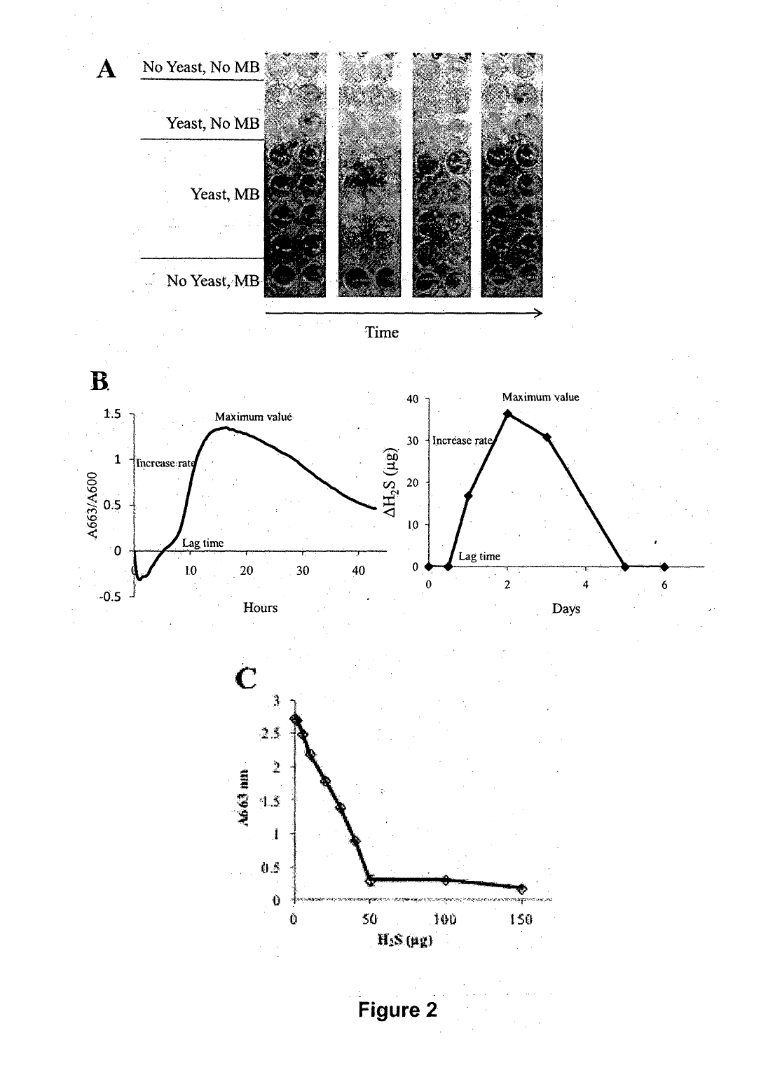

Comparison of the methylene blue reduction (MBR) method profile with a quantitative H₂S production profile, obtained using H₂S detection tubes, shows similar trends (FIG. 2). Both profiles show an initial lag followed by increased rate of H₂S production, an H₂S maxima, and then production of smaller amounts of H₂S (FIG. 2). Kinetic parameters can be extracted from the MBR method profile using a locally weighted regression (loess) algorithm (supplementary data) (FIG. 2): Table 1 shows reproducibility of kinetic parameters extracted from inter-plate, triplicate cell cultures of the yeast AWRI1631. Due to equilibrium of the chemical reaction, once H₂S production slowed, H₂S evaporation altered the rate of the reaction and methylene blue re-colourised within the cell culture media (FIG. 2). As a consequence, precision of kinetic parameters extracted following the point of maximum H₂S detection is limited.

TABLE 1
Kinetic parameters extracted from AWRI1631 micro cell culture

| | | Increase rate | |
|---|---|---|---|
| | Lag time (AU) | (AU) | Maximum value (AU) |
| Replicate 1 | 9.5 | 0.09 | 0.83 |
| Replicate 2 | 10.92 | 0.12 | 0.69 |
| Replicate 3 | 9.42 | 0.096 | 0.9 |
| Average (AU) | 9.95 | 0.10 | 0.81 |
| CV (%) | 8.48 | 15.56 | 13.26 |

### Detection Threshold and Linearity

To construct a calibration curve, known volumes of aqueous solution of Na₂S.9H₂O (final H₂S concentration of 1 mg/ml) previously standardized by means of iodine-thiosulfate titration were added to a cell culture media containing methylene blue reaction mix and were monitored at 663 nm for 30 minutes. The MBR method displayed linearity between the ranges of 0-50 μg H₂S (FIG. 2). Samples spiked with Na₂S.9H₂O plus potassium bisulphate (final SO₂ concentration of 50 mg/L), dimethyl sulfide (1 mg/ml) and methyl mercapto acetate (1 mg/ml) were also tested under the same conditions. No interference in H₂S detection was observed following the additions.

### Method Validation

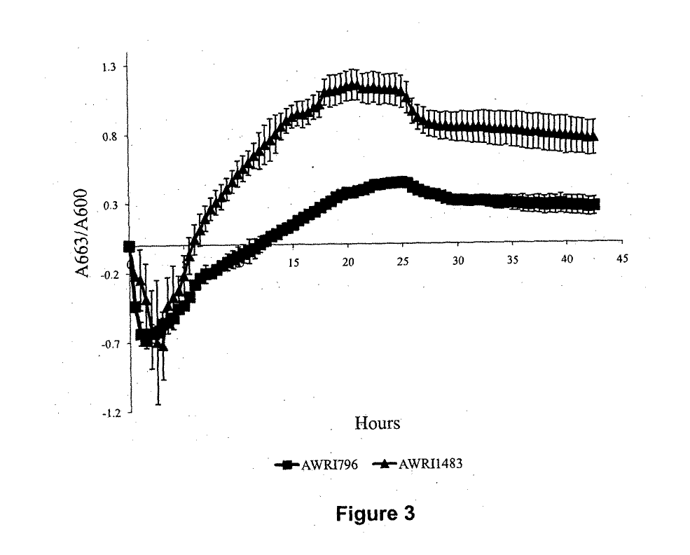

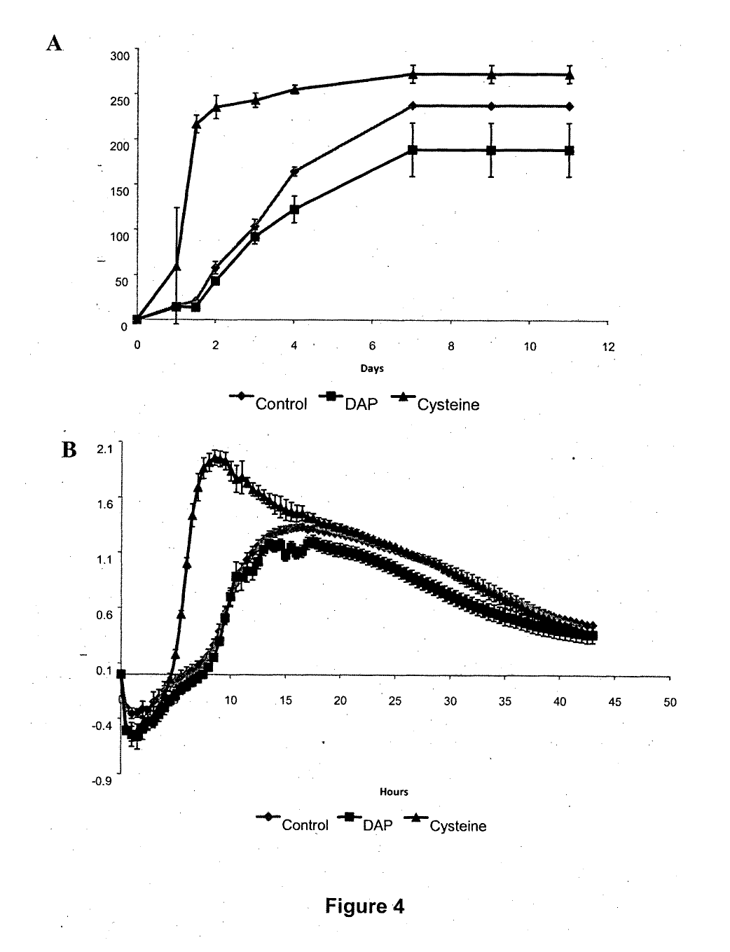

Method validation was carried out by measuring H₂S profiles for known high and low H₂S producing strains, AWRI1483 and AWRI796, respectively. From 5 hrs post-inoculation AWRI1483 produced H₂S at a greater rate than, and reached a greater maximum value, in comparison to AWRI796 (FIG. 3), in agreement with previous work utilising quantitative methods. The MBR method was also tested for its ability to detect different environmental factors affecting H₂S production, including media yeast assimilable nitrogen (YAN) and cysteine concentration. Quantitative determination of H₂S produced during cell culture, using detection tubes, demonstrated that increasing YAN concentration of the media from 150 mg N/L to 350 mg N/L through addition of diammonium phosphate (DAP) decreased the amount of H₂S produced. Addition of freshly made cysteine solution, at a concentration of 500 mg/L decreased the lag time for H₂S production and increased both the rate and amount produced (FIG. 4a). Concurrent cell cultures evaluated on a micro-scale cell culture using the MBR method displayed the same trends. DAP addition decreased the H₂S production maxima while cysteine addition decreased lag time, increased both H₂S production rate and maximum value (FIG. 4B).

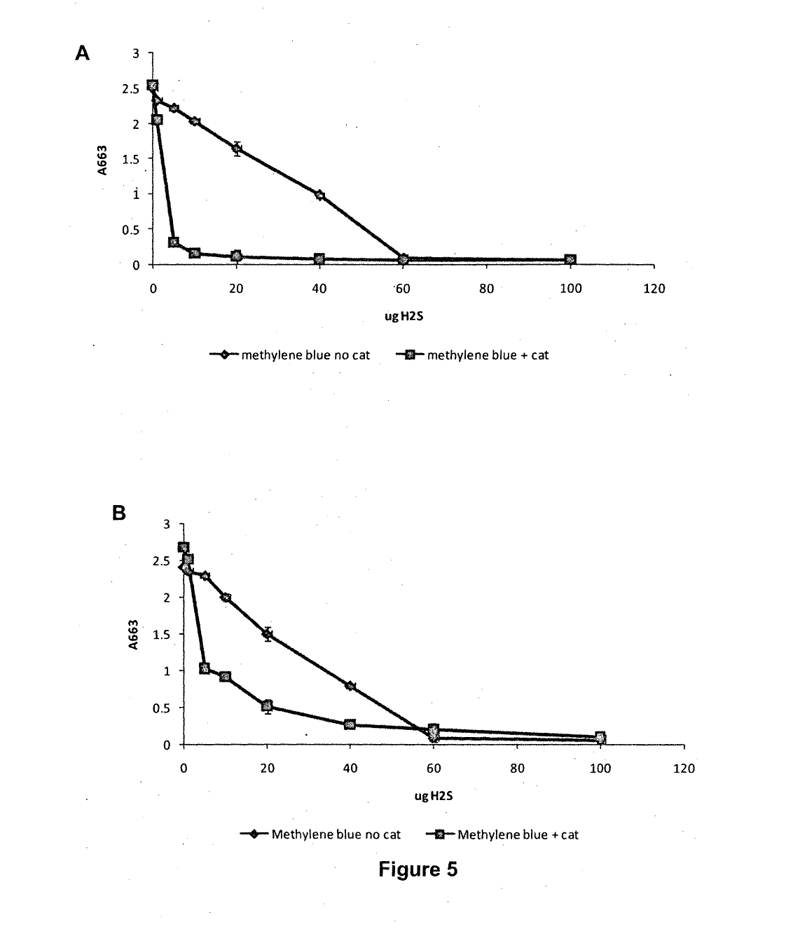

Using methylene blue as the thiazine dye (FIG. 5) the method of the invention was used to detect known amounts of H₂S (up to 100 μg) in a 96 well plate filled water and the reaction mix (final concentration of 50 mM citric acid, pH 4.5, 0.5 mg/ml methylene blue) with or without addition of a catalyst (0.01 mg/ml tellurium dioxide). Dye absorbance was measured at 663 nm wavelength immediately following dye addition (FIG. 5A) and after 30 minutes (FIG. 5B).

Using Azur A as the thiazine dye (FIG. 6) known amounts of H₂S (up to 100 μg) were added into a 96 well plate filled water and the reaction mix (final concentration of 50 mM citric acid, pH 4.5, 0.5 mg/ml azur A) with or without addition of a catalyst (0.01 mg/ml tellurium dioxide). Dye absorbance was measured at 663 nm wavelength immediately following dye addition (FIG. 6A) and after 30 minutes (FIG. 6B). Reactions were carried out in triplicates.

Using Touidine blue as the thiazine dye (FIG. 7) known amounts of H₂S (up to 100 μg) were added into a 96 well plate filled water and the reaction mix (final concentration of 50 mM citric acid, pH 4.5, 0.5 mg/ml toluidine blue) with or without addition of a catalyst (0.01 mg/Ml tellurium dioxide). Dye absorbance was measured at 663 nm wavelength immediately following dye addition (FIG. 7A) and after 30 minutes (FIG. 7B). Reactions were carried out in triplicates.

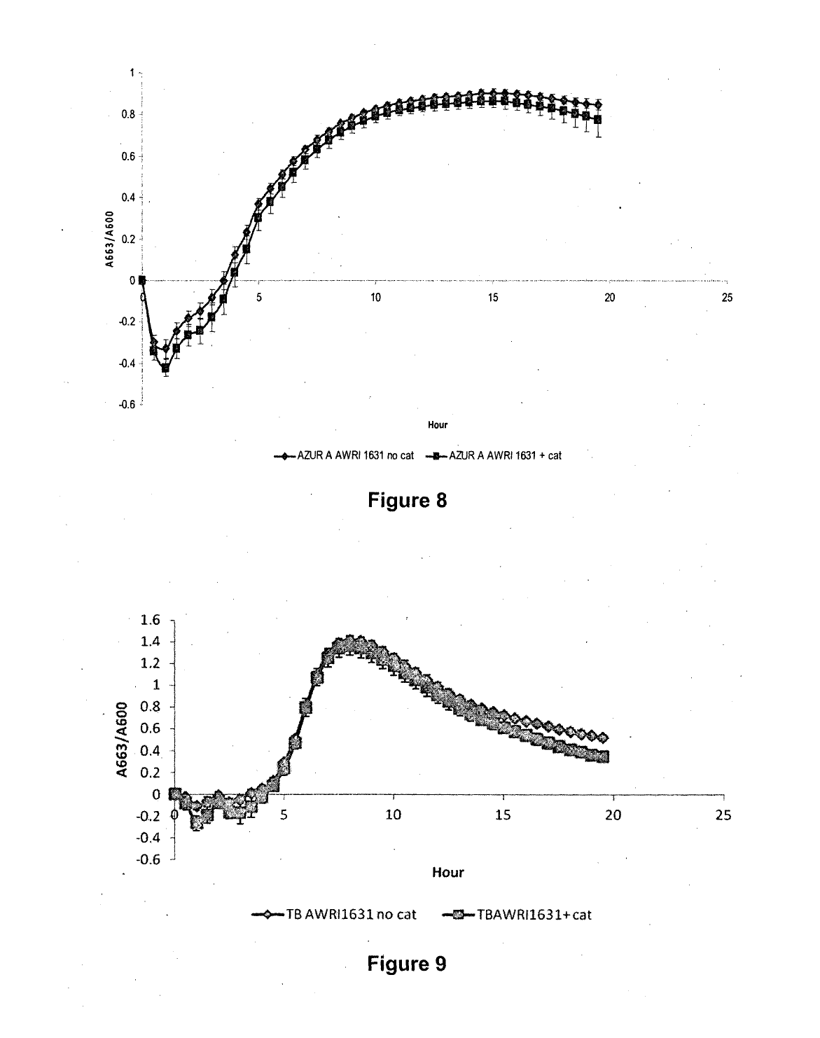

The H₂S formation profile detected using Azur A is illustrated in FIG. 8. The H₂S formation profile was generated on a micro-scale fermentation using Azur A colour degradation reduction method of the invention. Fermentations were carried out in quadruplicates.

The H₂S formation profile detected using Toluidine blue is illustrated in FIG. 9. The H₂S formation profile was generated on a micro-scale fermentation using toluidine blue colour degradation reduction method of the invention. Fermentations were carried out in quadruplicates.

### Method Applicability

H₂S production is an evolutionary conserved phenomenon. Applicability of the MBR method to various cell culture systems was tested using micro-scale cell cultures of various microorganisms (Table 2). H₂S production was detected in all cell cultures. Moreover, differences in H₂S production due to cysteine addition were detected using this method (Table 2).

### CONCLUSIONS

This in situ method for H₂S detection during cell culture. Kinetic parameters obtained using this method can be successfully used for profiling H₂S production in various cell culture systems, enabling detection of different environmental sources for H₂S production. The method is suited for high throughput screening purposes by virtue of its simplicity and ability to detect H₂S during cell culture.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

TABLE 2
H₂S formation kinetic parameters for various microorganisms

| | Lag | Increase | Maximum | Lag | Increase | Maximum | | | |
|---|---|---|---|---|---|---|---|---|---|
| | Time | Rate | Point | Time | Rate | Point | | | |
| | (Hours) | (AU) | (AU) | (Hours) | (AU) | (AU) | Growth | Temperature | |
| Organism | −Cysteine | | | +Cysteine | | | media | (° C.) | Comments |
| Candida stellata | 22.29 | 0.17 | 0.97 | 3.88 | 0.035 | 0.84 | Model grape | 30 | |
| | | | | | | | juice | | |
| Kluyveromyces | 4.46 | 0.08 | 0.916 | 5.75 | 0.314 | 1.45 | Model grape | 30 | |
| | | | | | | | juice | | |
| Schizosaccharomyces | 6.7 | 0.5 | 1.68 | 7.32 | 0.209 | 2.52 | Model grape | 28 | Cysteine |
| pombe | | | | | | | juice | | addition caused |
| | | | | | | | | | growth inhibition |
| Hanseniaspora | 1.13 | 0.199 | 1.33 | 1.43 | 0.385 | 1.88 | Model grape | 20 | Cysteine |
| | | | | | | | juice | | addition caused |
| | | | | | | | | | growth inhibition |
| Saccharomyces | 5.52 | 0.005 | 0.398 | 3.77 | 0.44 | 1.65 | Model grape | 28 | |
| cerevisiae (BY4742) | | | | | | | juice with 10% | | |
| | | | | | | | sugars and the | | |
| | | | | | | | auxotrophic | | |
| | | | | | | | amino acids | | |
| Oenococcus oeni | 17.05 | 0.22 | 2.35 | | | | Model grape | 20 | Cysteine |
| | | | | | | | juice | | addition caused |
| | | | | | | | | | growth inhibition |
| Escherichia coli | 16 | 0.2 | 0.6 | 3.25 | 0.4 | 1.7 | LB (1% tryptone, | 37 | |
| (DH5α) | | | | | | | 1% sodium | | |
| | | | | | | | chloride, 0.5% | | |
| | | | | | | | yeast extracts) | | |

1. A method for detecting H₂S produced by a microorganism comprising:
(a) providing a thiazine dye to a culture medium;
(b) culturing a microorganism in the culture medium; and
(c) detecting H₂S produced by the microorganism by determining a colour change of the culture medium from an interaction of the thiazine dye with H₂S present in the culture medium.

2. The method of claim 1 in a high throughput mode wherein in step (a) the thiazine dye is provided to a plurality of vessels containing culture media; in step (b) the microorganisms are cultured in the plurality of vessels; and in step (c) H₂S produced by the microorganisms is detected by determining colour change of the culture media from an interaction of the thiazine dye with H₂S in the plurality of vessels.

3. The method of claim 2 wherein the plurality of vessels is a 12, 24, 48 or 96 well microtitre plate.

4. The method of claim 1 further comprising providing an agent to the culture medium, culturing the microorganism, and comparing H₂S production by the microorganism under similar culture conditions to those in step (c) in the absence of the agent to determine any effect of the agent on H₂S production by the microorganism.

5. The method of claim 4 wherein the agent is selected from the group consisting of a nutrient, co-factor, food additive, food component, substrate, amino acid, peptide, protein, metal, and vitamin.

6. The method of claim 1 wherein the culture medium is a food or beverage or a medium derived from a food or beverage.

7. The method of claim 6 wherein the sample of food or beverage is diluted to form the medium.

8. The method of claim 1 wherein the thiazine dye is selected from the group consisting of Methylene blue, Azure A, Azure B, Azure C, Methylene green, New methylene blue, Tolonium chloride, Toluidine Blue, Thionine, chemical variations thereof, and any combinations thereof.

9. The method of claim 8 wherein the thiazine dye is Methylene blue or Azure A.

10. The method of claim 1 further comprising providing a catalyst to the culture medium.

11. The method of claim 10 wherein the catalyst is a transition metal cation.

12. The method of claim 11 wherein the transition metal cation is selected from the group consisting of a cation of selenium, tellurium, titanium, and any combination thereof.

13. The method of claim 12 wherein the transition metal cation is provided at a concentration of 1 μg/ml to 1 mg/ml.

14. The method of claim 1 wherein the thiazine dye is added to the culture medium as a mix containing a thiazine dye and a catalyst.

15. The method of claim 1 wherein the colour change is determined at a visible wavelength in the range of 380 nm to 750 nm.

16. The method of claim 15 wherein the visible wavelength is between 600 nm to 663 nm.

17. The method of claim 16 wherein the visible wavelength is 663 nm.

18. The method of claim 1 wherein the microorganism is a bacterium or a yeast.

19. The method of claim 18 wherein the bacterium is a Oenococcus sp or Escherichia sp.

20. The method of claim 18 wherein the yeast is a Candida sp, Kluyveromyces sp, Hansenaspora sp or Saccharomyces sp.
